(19) United States
(12) Patent Application Publication
(10) Pub. No.: US 2004/0047312 A1
(43) Pub. Date: Mar. 11, 2004

(54) Method and apparatus for UL interference avoidance by DL measurements and IFHO

(76) Inventors: Peter Muszynski, Espoo (FI); Uwe Schwarz, Veikkola (FI); Harri Holma, Helsinki (FI); Jussi Numminen, Turku (FI); Kjell Ostman, Halikko (FI); Kari Rikkinen, Camberley (GB); Achim Wacker, Espoo (FI)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 10/421,890

(22) Filed: Apr. 24, 2003

Related U.S. Application Data
(60) Provisional application No. 60/375,838, filed on Apr. 29, 2002.

(51) Int. Cl. H04Q 7/00

(52) U.S. Cl. 370/331

(57) ABSTRACT

A method and system for uplink interference avoidance that includes a network device and mobile device in a communications network. A signal characteristic of a downlink channel currently not used by the mobile device is measured to determine if the signal characteristic has increased or decreased. The signal characteristic increase or decrease is reported to the network device. The signal characteristic may be, for example, signal quality or signal strength. The interference may be, for example, adjacent channel leakage power ratio (ACLR) interference. A handover from the downlink channel currently used by the mobile device is launched thus avoiding interference in an uplink channel not currently used by the mobile device. An inter-frequency handover or an inter-system handover may be launched.

This application claims the benefit of U.S. Provisional Patent Application serial No. 60/375,838 filed Apr. 29, 2002, the contents of which is expressly incorporated by reference herein.

### BACKGROUND

1. Field of the Invention

This invention relates to CDMA systems, and more specifically to uplink interference avoidance in CDMA systems.

2. Description of the Related Art

In Code Division Multiple Access (CDMA) systems, a soft handover (SHO) area is characterized by similarly strong pilot power signals (CPICH Ec/Io in Wideband CDMA (WCDMA)). Pilot powers are measured by the mobile in idle as well as in connected mode. In connected mode, it is very important that the mobile device (UE) is always connected to the optimum cell(s). Otherwise, it would cause significant interference in uplink and waste network capacity. In idle mode, it is important to camp in the strongest cell to allow a quick call initiation and not cause interference during call initiation.

There is currently an evolution of UMTS Terrestrial Radio Access Network (UTRAN), in which in addition to the current uplink-downlink (UL-DL) frequency pairing within the Third Generation (3G) core bands, additional carriers within an extension band (e.g., 2.5 GHz bands but not limited to) are used only for DL operation. Therefore, radio connections (RC) pertaining to one particular core band UL carrier can be carried on one or more than one DL carrier. However, each radio link uses at most one DL carrier (either in a core band (e.g., frequencies starting at approximately 2 GHz) or in an extension band (e.g., frequencies starting at approximately 2.5 GHz)) at each point in time. Variable duplexing in the mobile device (e.g., mobile node (MN), User Equipment (UE), mobile station (MS), mobile phone, etc.) is used to access the additional carrier(s) outside the core band.

However, in such a system problems exist with respect to adjacent channel leakage power ratio (ACLR) related interference on the UL. The ACLR is the ratio of the transmitted power to the power measured in one of the adjacent channels. This measurement is defined in 3GPP TS 34.121, section 5.10, v3.2.0, Adjacent Channel Power Leakage Ratio (ACLR).

In current UTRAN there exists inheritently a safety mechanism, in which UEs, which could possibly cause UL interference, will loose their connection due to excessive adjacent channel interference (ACI) on DL first (“the DL dies first” principle), thus avoiding the UL interference before it would become significant, i.e. before a single UE could possibly block a whole cell due to interference, the single UE looses its connection in DL. However, in systems with the extension bands, due to the additional DL carriers in the extension (e.g., 2.5 GHz) bands and variable duplexing, the UL may be paired with a non-ACI-interfered DL carrier in the non-core (e.g., 2 GHz) bands. The DL from the possibly interfered cell in UL does not interfere the UE in DL anymore, since this UE is using the extension band DL carrier. Therefore, the “the DL dies first” principle does not work any longer, thus the UE possibly causes severe UL interference due to ACLR interference. This situation is especially critical, when there are two uncoordinated operators, where operator 1 is using UUDL channels ch1 and operator 2 using UL channel ch2 and DL ch2. The worst case is possibly that of operator 1 (the victim) using microcells and operator 2 macrocells. Macrocells typically are larger, cover a larger area, and transmit more power than microcells. FIG. 6 shows a diagram of an example ACLR problem scenario. In this scenario, a mobile device 80 having associated DL ch2 and UL ch2 from one Base Transceiver Station (BTS) 82 causes ACLR interference in an UL ch1 from a second BTS 84. Another problem may exist if the procedure to detect and avoid ACI is imposed by the 3GPP standard as non-optional and the UE must possibly take appropriate actions without being commanded by the network.

### SUMMARY OF THE INVENTION

The present invention relates to a method and system for uplink interference avoidance that includes a network device and mobile device in a communications network. A signal characteristic of a downlink channel currently not used by the mobile device is measured to determine if the signal characteristic has increased or decreased. The signal characteristic increase or decrease is reported to the network device. The signal characteristic may be, for example, signal quality or signal strength. The interference may be, for example, adjacent channel leakage power ratio (ACLR) interference. A handover from the downlink channel currently used by the mobile devcie is launched thus avoiding interference in an uplink channel not currently used by the mobile device. An inter-frequency handover or an inter-system handover may be launched.

### BRIEF DESCRIPTION OF THE DRAWINGS

The present invention is further described in the detailed description which follows in reference to the noted plurality of drawings by way of non-limiting examples of embodiments of the present invention in which like reference numerals represent similar parts throughout the several views of the drawings and wherein:

FIG. 1 is a diagram of a system for soft handover detection according to an example embodiment of the present invention;

FIG. 2 is a diagram of mobile node measurement activities during different mobile node states according to an example embodiment of the present invention;

FIGS. 3A and 3B are diagrams of uplink and downlink carrier pairings according to example embodiments of the present invention;

FIG. 4 shows a flowchart of a process for uplink interference avoidance according to an example embodiment of the present invention;

FIG. 5 shows a flowchart of a process for uplink interference avoidance according to another example embodiment of the present invention; and

FIG. 6 is a diagram of an example ACLR problem scenario.

### DETAILED DESCRIPTION

The particulars shown herein are by way of example and for purposes of illustrative discussion of the embodiments of the present invention. The description taken with the drawings make it apparent to those skilled in the art how the present invention may be embodied in practice.

Further, arrangements may be shown in block diagram form in order to avoid obscuring the invention, and also in view of the fact that specifics with respect to implementation of such block diagram arrangements is highly dependent upon the platform within which the present invention is to be implemented, i.e., specifics should be well within purview of one skilled in the art. Where specific details (e.g., circuits, flowcharts) are set forth in order to describe example embodiments of the invention, it should be apparent to one skilled in the art that the invention can be practiced without these specific details. Finally, it should be apparent that any combination of hard-wired circuitry and software instructions can be used to implement embodiments of the present invention, i.e., the present invention is not limited to any specific combination of hardware circuitry and software instructions.

Although example embodiments of the present invention may be described using an example system block diagram in an example host unit environment, practice of the invention is not limited thereto, i.e., the invention may be able to be practiced with other types of systems, and in other types of environments.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

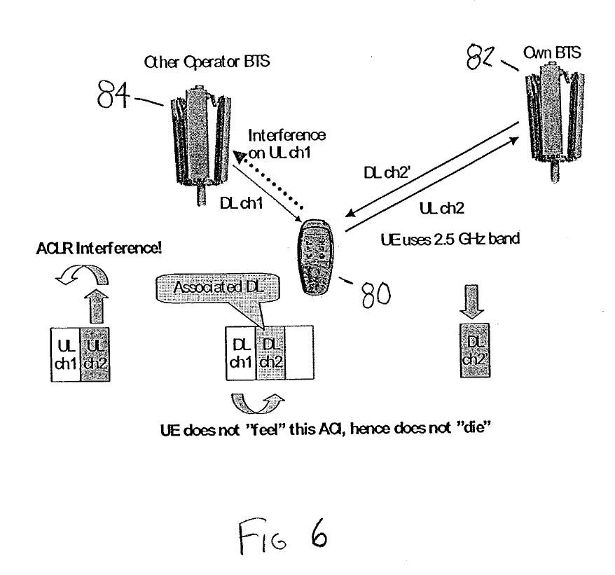

The embodiments of the present invention relate to method and apparatus for uplink (UL) channel interference avoidance by downlink (DL) channel measurements and inter-frequency handover (IFHO). This includes possible ways of detecting the situation of possible UL interference, e.g., due to ACLR, by appropriate UE measurements of DL carriers, resulting in UL interference avoidance by UE DL measurement reporting to the network (via a network device) and subsequent inter-frequency handover (IFHO). To help illustrate the present invention, it may be assumed that in all cases the UE is using UL channel ch2 (in an extension band, e.g., frequencies starting at approximately 2.5 GHz) and DL channel ch2′ (in the extension band) (see FIG. 6).

In one embodiment of the invention, while the UE demodulates DL channel ch2′ and may perform on it the usual intra-frequency Radio Resource Management (RRM) measurements, e.g. CPICH Ec/Io for soft HO purposes, the UE may also regularly measure the “signal quality” on DL channel ch2. This could be, e.g., as well the CPICH Ec/Io. These measurements could follow, e.g. an appropriate compressed mode (CM) pattern, as used already in UTRAN, e.g., for inter-frequency RRM measurements.

If there is a potential adjacent channel interference situation, DL channel ch2 may become heavily interfered due to ACI and the “signal quality” (e.g., CPICH Ec/Io) of DL channel ch2 may thus be low. This condition may then be signalled to the network via a network device (e.g., a radio network controller (RNC), base station controller (BSC), etc.) and a IFHO or ISHO (inter-system handover) could be launched, moving the UE away from UL channel ch2 and thus avoiding the possible ACLR into UL channel ch1.

In another embodiemnt of the present invention, while the UE demodulates DL channel ch2′ and may perform on it the usual intra-frequency RRM measurements, e.g. like CPICH Ec/Io for soft HO purposes, it may also regularly measure the “signal strength” on the adjacent operators DL channel ch1. This could be, e.g., some RSSI measurement. These measurements could follow, e.g., an appropriate compressed mode (CM) pattern, as used already in UTRAN, e.g., for inter-system RRM measurements. In a potential adjacent channel interference situation, DL channel ch1 may be received very strongly. This condition may then be signalled to the network and a IFHO or ISHO may be launched, moving the UE away from UL channel ch2 and thus avoiding the possible ACLR into UL channel ch1.

Other embodiments of the present invention may incorporate a combination of performing frequently the signal strength measurements and if and only if a strong adjacent carrier is detected, trigger measurements (and possible subsequent reporting to the network) of of the signal quality.

If in an embodiment of the present invention where DL RRM measurements+subsequent IFHO is the selected mechanism to avoid the UL interference problem, then it may be a mandatory procedure in the UE, not something the network operator 2 could disable/control, as it may be required for operator 1's protection from operator 2's interference. Alternatively to compressed mode, in some embodiments of the present invention, a dual receiver mobile device may use the second receiver for the above measurements.

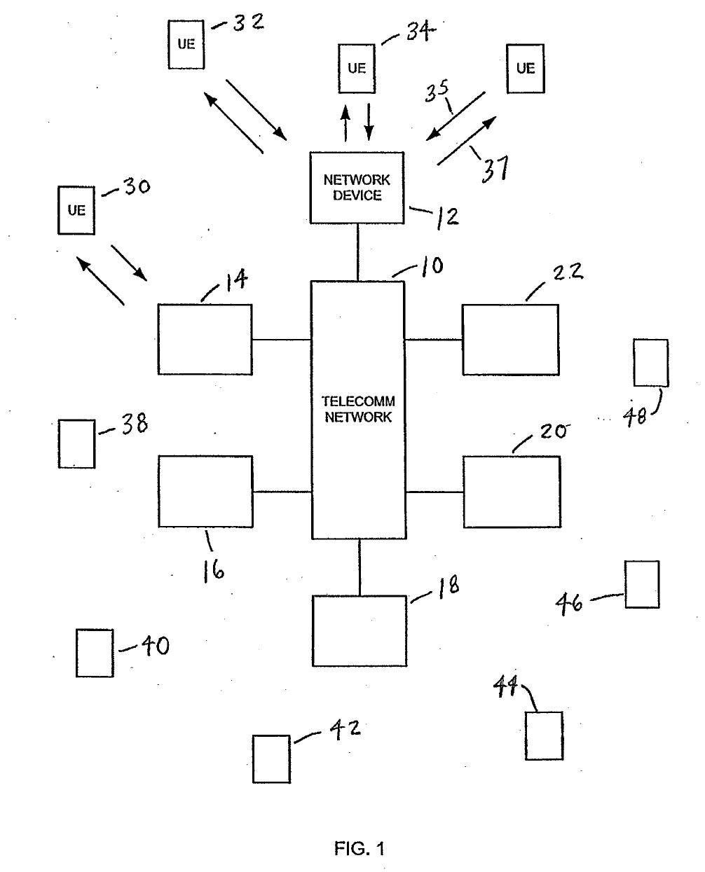

FIG. 1 shows a diagram of a system for soft handover detection according to an example embodiment of the present invention. The system includes a telecommunications network 10 that includes network devices or nodes 12-22 and mobile devices (e.g., user equipment (UE), mobile nodes (MN), mobile stations (MS), etc.) 30-48. The terms mobile device, mobile node, and user equipment will be used interchangeably throughout the illustration of the embodiments of the present invention and refer to the same type of device.

Network devices 12-22 may be any type of network node or device that supports wireless devices connected to a telecommunications network, for example, a Radio Network Controller (RNC), a Base Station Controller (BSC), etc. Network device 12 and mobile device 36 transfer data and control information between each other via uplink 35 and downlink 37 channels. A base station or cell (not shown) may supply frequencies from a particular band of frequencies that allow a mobile device 36 to select from and use for a downlink carrier and uplink carrier. The uplink carrier frequency and downlink carrier frequency may be from the same band of frequencies, or from different bands of frequencies.

As a mobile device moves from one location to another, the base station or cell closest to the mobile device will likely then supply the uplink and downlink carriers for the particular mobile device. Generally, if the same band of frequencies is available at the neighboring base station, the network device may direct a soft handover to occur between the downlink and uplink carriers supplied from the original base station to downlink and uplink carriers supplied from the neighboring base station.

According to the present invention, a currently used network device 12 and/or neighboring network device 14, possibly along with mobile device 36, may detect soft handover areas before a handover is to occur such that a handover may occur without causing uplink channel interference. As noted previously, uplink interference may be caused when a mobile device moves to a location that does not supply the same bands of frequencies currently being used by the mobile device for its downlink carrier.

Each mobile device 30-48 and/or network device 12-22 may perform various measurements in a periodic or continuous basis to detect soft handover areas for uplink interference avoidance. For example, measurements such as signal strength, signal quality, etc. may be made and compared with similar measurements of carriers from neighboring or co-sited bands to determine if a soft handover area exists and whether a handover should occur to avoid uplink interference. A network device and/or mobile device may determine the types of measurements made and when they are made. Moreover, a network device and/or mobile device may perform the measurements, where in the latter case, a network node may instruct the mobile device to perform the measurements or the mobile device perform the measurements without instruction from the network device. Further, the mobile device may perform the measurements and report the results to the network device whereby the network device decides whether a soft handover area exists and whether a soft handover should occur to avoid uplink interference.

Signal quality of a carrier (downlink or uplink) may include interference from other cells and is related to the signal quality at a specific mobile device. In contrast, signal strength may include the sum of all the signals and indicates the total strength in a specific frequency. With signal strength measurements, there is no differentiating between a particular mobile device's signal and other signals. Co-sited downlink carriers are downlink carriers from the same antenna or same base station or cell as the downlink carrier currently being used by a mobile device.

Relative signal quality may also be a measurement performed. In this method, signal quality may be measured and compared with the signal quality of downlink carriers from another base station. Differences between the two may be then used to determine if a soft handover area exists. Moreover, a mobile device currently using a current downlink carrier from a current cell and moving closer to a neighboring cell may look for a downlink carrier from the neighboring cell from the same frequency band as the current downlink carrier. If a downlink carrier is missing in this band, then the network device and mobile device know that a soft handover area exists where uplink interference may occur if the handover doesn't occur earlier.

Soft handover area detection may occur while a mobile device is in any mode or state, for example, the mobile device may be in an idle mode, or a connected mode where it is waiting for data or actively transmitting data. Depending on the mode or state of the mobile device, may determine what types of measurements (e.g., inter-frequency measurements) may be made.

One reason for handover may be because the mobile device has reached the end of coverage of a frequency carrier in an extension (e.g., 2.5 GHz) band. The end of extension band coverage may invoke inter-band, inter-frequency or inter-system handover. The trigger criteria may always be the same. As inter-band handovers can possibly be done faster, separate trigger thresholds might be implemented. Some example coverage triggers for example implementations according to the present invention may include but are not limited to: handover due to Uplink DCH quality, handover due to UE Tx power, handover due to Downlink DPCH power, handover due to common pilot channel (CPICH) received signal code power (RSCP), and handover due to CPICH chip energy/total noise (Ec/No).

Coverage may be another reason for handover. A coverage handover may occur if: (1) the extension band cell has a smaller coverage area (=lower CPICH power or different coverage triggers) than a core band, (2) currently used core band coverage ends (then also extension band), or (3) the UE enters a dead zone.

Intra-frequency measurements may be another reason for soft handover. A soft handover procedure in an extension band may work in principle the same way as in core bands with branch addition, replacement and deletion procedures. SHO procedures may be based on CPICH Ec/I0 measurements. Despite stronger attenuation in the extension band, Ec/I0 as a ratio may be about the same for both bands. Therefore, in principle the same SHO parameter settings may be used in the extension band. However, if stronger attenuation in an extension band is not compensated for by additional power allocation, the reliability of SHO measurements (Ec/Io) may suffer. Moreover, an extension band cell might have neighbors on extension band frequencies and on core band frequencies at the same time. Then, the UE may have to measure both intra-frequency and inter-band neighbors.

UL interference in the core bands due to delayed soft HO at the extension band coverage edge may occur. An extension band cell may have both extension band neighbors and core band neighbors at the same time. While for the extension band neighbor the normal SHO procedure may be sufficient, for the core band neighbor an early enough inter-band handover may have to be performed. Otherwise, serious UL interference could occur in the core band neighbor cell. SHO areas might be located relatively close to the base station and thus not necessarily relate to high UE Tx (transmit) power (or base transceiver station (BTS) Tx power). Coverage handover triggers may not be sufficient.

In order to prevent a directed RRC connection setup into an interfering area, the UE (mobile device) may need to report in a RACH message the measured neighbors in the core band. The message attachment may be standardized but may need to be activated. A network node (e.g., Radio Network Controller (RNC)) then may need to check that all measured cells have a co-sited neighbor in the extension band.

Adjacent cell interference (ACI) detection before the directed setup is automatically given if FACH decoding in the core band was successful. Load reason handover may be needed in addition to Directed RRC connection setup for congestion due to mobility. The load reason handover in current implementations is initiated by UL and DL specific triggers. By setting the trigger thresholds the operator can steer the load balancing:

for load threshold for RT users, in UL the total received power by the BTS relative to the target received power (PrxTarget) and in DL the total transmitted power of the BTS relative to the target transmitted power (PtxTarget);

for NRT users: rate of rejected capacity requests in UL & DL;

Orthogonal code shortage.

In 2.5 GHz operation, UL load may only be balanced by inter-frequency and inter-system handovers whereas DL load may be balanced in addition by inter-band handovers. So, when considering inter-band handovers (UL stays the same) only DL triggers may be important.

One way to guarantee avoidance of UL interference in a core band (e.g., a band with frequencies starting at approximately 2.0 GHz) SHO area is to continuously monitor the core band DL CPICH Ec/Io in the cells where needed, (i.e., in coverage edge cells), and if a SHO area in the core band is detected initiate an inter-band handover.

An inter-band handover core band-to-extension band may not occur in cells underlying a extension band coverage edge cell if the UE is in a SHO area. Specifically, a load/service reason inter-band handover during SHO in core bands may not be allowed. Also, inter-band handover core band-to-extension band due to an unsuccessful soft handover (branch addition) procedure may be disabled, but inter-frequency HO allowed.

Compressed mode may also be used for avoidance of adjacent channel protection (ACP)-caused UL interference. ACP caused UL interference may occur at certain UE Tx power levels where the UE location is close to an adjacent band base station. This is mostly a macro-micro base station scenario. The interfered base station may be protected in DL if it is operating in the adjacent extension band carrier otherwise not.

Adjacent channel interference (ACI) probability may directly relate to the mobile device's transmission power. Below certain powers the mobile cannot interfere to the micro base station and interference detection may not be required. A reasonable value for the power threshold that determines when to start interference detection may need to take into account the statistical probability of MCL (minimum coupling loss) situations, adjacent channel leakage power ratio (ACLR), micro BTS noise level and desensitization. If the power is around the average UE Tx power (=−10 . . . 10 dBm) or higher, the number of mobile devices continuously checking for ACI interference may be reduced significantly.

An interfered base station may not be able to protect itself from ACI interference. The interfering mobile device must voluntarily stop transmission on its current band. Only by also operating in an extension band is the interfered base station self-protected.

Regarding compressed mode operation in an extension band (Cell_DCH), when the UE is operating in the extension band and needs to measure the core DL bands, CM usage in the core band can be applied normally and balancing of UL load may be triggering separately interfrequency measurements. As described previously, there may be several reasons for inter-band CM measurements when the UE is in the extension band.

Since the DL load of the other band may be known, a network device (e.g., RNC) may initiate instead of an inter-band handover directly, an inter-frequency or inter-system handover in case of high load. Then, separate inter-frequency/inter-system measurements may be performed. In order to minimize the effects on network performance, CM may need to be used very efficiently and one consistent CM usage strategy may need to cover all inter-band measurements. The most excessive CM usage may come from “ACI detection” and “SHO area detection”. Both of these may be continuous in case they are needed. Both may be largely avoided either by intelligent carrier allocation in the extension band or by network planning.

Most of the carriers may be protected by carrier allocation. Only if an existing operator is not interested in extension band (e.g., 2.5 GHz) deployment, the UL adjacent carriers may need the ACI detection to protect another carrier from UL interference. Also, if operators want to have different numbers of extension band carriers, at some point, the UL carrier pattern may not be repeatable anymore in the extension band. Further, since a first operator may not use its additional carriers in the same geographical area and starting at the very same time as a second operator, ACI detection may be needed wherever protection from the extension band adjacent carrier is not provided.

UL carriers in the TDD band may be automatically protected because here the UL carrier may exist only if also extension band is deployed. However, the adjacencies between TDD band and UL band may need special attention as again a first UL carrier can be interfered by a second if it is not (yet) operating in the extension band.

Regarding SHO area detection, network planning can reduce the need of CM by limiting the number of extension coverage edge cells and indicating edge cells via RNP parameters. If sectorized cells in the core band are fully repeated in the upper band, i.e., no softer handover area in the UL that is not a softer handover area in the extension band, the detection of SHO areas may be made dependent on the UE transmission power or CPICH Ec/Io. However here, it is more difficult to determine a threshold since there is no general limitation how close base stations can be to each other. If almost complete extension band coverage is needed it might be wise not to save on single sites and rather make the coverage as complete as possible. Moreover, if sparse capacity extension is needed, one can consider having less coverage area in the extension band cell by lowering the CPICH pilot power or applying different coverage handover thresholds. This lowers the average UE transmission power in the sparse cell and thus the probability of ACI or unwanted entering in UL SHO area.

Non-regarding network planning, there are still some cells where all reasons for CM are given. Here, the CM usage must be made efficient.

Most all reasons for CM require measurement of the associated DL core band, either own cell or neighbors. ACI detection can also be obtained by measuring the received signal strength indicator (RSSI) of the adjacent carriers in the core. If both SHO area detection and ACI detection is needed, it may be more efficient to rely for both on Ec/lo measurements provided that latter measurement can be done quickly enough. This may be enabled for two reasons: (1) CM in extension band operation can use the fact that extension band DL and core band DL are chip synchronized (assuming they are in the same base station cabinet, i.e., co-sited), and (2) both DL bands have the same or at least very similar propagation path differing merely in stronger attenuation for the extension band.

Two options for chip energy/system noise measurements may include: (1) measure core band average channel power-to-total signal power (Ec/Io) (fast due to chip synchronization)—more accurate, may require a measurement gap of 4-5 timeslots, and (2) measure core band RSSI and use CPICH Ec correlation between bands=>Ec/Io—may require a measurement gap of 1-2 timeslots.

The second option may be preferred due to the short gaps. Basically, not even level measurements (Ec/Io) are required if the relative difference between both DLs RSSI is considered. Uncertainties on the network side (antenna pattern/gain, cable loss, loading, PA rating, propagation loss/diffraction) as well as on the UE side (measurement accuracy) may disturb the comparison and may need to be taken into account if possible.

If a high difference in RSSIs (or low Ec/Io in the core band) is detected, the reason may be verified by:

measure associated core cell's neighbors->if SHO area (little i) make inter-band handover;

measure adjacent channel RSSI->if ACI make inter-frequency HO;

none of above true->no action required (associated core cell's load might be high).

In case (a), handover happens directly to a SHO area. This may require a fast enough branch addition after the inter-band hard handover.

Additionally, CM usage can be minimized by triggering it with some kind of UE speed estimate. If a UE is not moving CM can be ceased, when it moves again CM continues.

Regarding measurements for cell re-selection when the extension band is used, the UE in idle mode camps in the extension band as long as Ec/Io signal is good enough. In connected mode, PS services move to Cell_FACH, UTRAN registration area routing area paging channel (URA_PCH), or Cell_PCH state after a certain time of inactivity (NRT). Then, idle mode parameters may control the cell re-selection. Cell re-selection may then happen for a coverage reason, i.e., when the extension band's coverage ends.

Interference detection may need to be provided also in states controlled by idle mode parameters to prevent UL interference due to RACH transmission. Here, for ACI and SHO area detection different mechanisms may be applied.

SHO area detection in idle mode (and Cell_PCH, URA_PCH) may be enabled by a two-step measurement and applied to the coverage edge cells: (1) a cell specific absolute Ec/Io-threshold triggers step, and (2) measure core band whether there is a cell without inter-band neighbor in extension band. To make the comparison, the UE may need to know the co-sited core neighbors. This may need to be added in extension band broadcast channel system information (BCCH SI). In Cell_FACH state, SHO areas may be detected by using the IF measurements occasions and checking if found neighbors in the core band have a co-sited neighbor in the extension band. Again additional BCCH information may be needed.

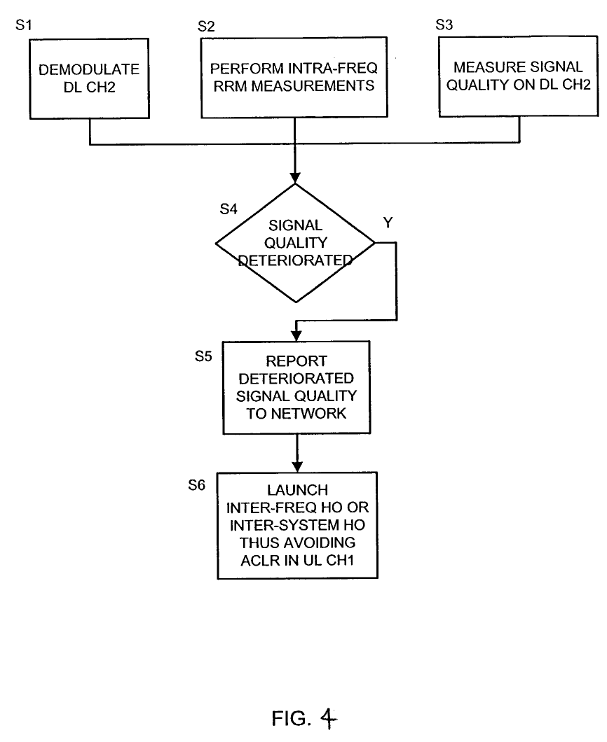

FIG. 4 shows a diagram of mobile node measurement activities during different mobile node states according to an example embodiment of the present invention. The different states of the mobile device are shown inside arrows at the top of the figure. The mobile device may be in idle state, cell FACH state, or cell DCH state. The timeline shown in FIG. 4 is divided in half where the top half represents measurements to detect soft handover (SHO) area, and the bottom half represents measurements to detect adjacent channel interference (ACI). The various measurements that occur for each area and during each state of the mobile device along the time line are shown inside the call-outs.

ACI may not be detected in idle mode but immediately before RACH transmission by measuring directly the two neighboring (adjacent) carriers in the core band. The delay in RACH transmission may be negligible due to the fast RSSI measurements. In Cell_FACH state, ACI detection may be provided by continuously measuring the adjacent core carriers (stealing slots for RSSI measurements).

In the case of the SHO area, the UE may initiate an inter-band handover to the core band. In case ACI is detected, the UE may initiate an inter-frequency handover (UL changes) similar to a conventional coverage reason cell re-selection.

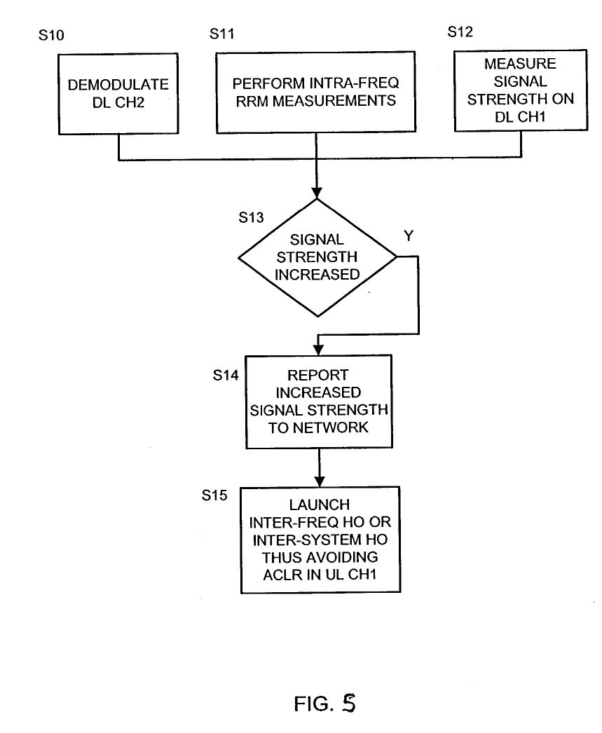

FIGS. 5A and 5B show diagrams of uplink and downlink carrier pairings according to example embodiments of the present invention. Uplink and downlink carriers from the existing band generally may be frequencies supplied by the same cell, but may be supplied from different cells. Similarly, uplink and downlink carriers from the new band may be frequencies supplied from the same cell (different from the cell supplying existing band frequencies). The A1, A2, A3, . . . represent different uplink/downlink frequency pairings. The frequencies in the box for each band starting with “A”, may be controlled by one operator at the cell, the frequencies in the blank boxes controlled by a second operator at the cell, and the frequencies in the darkened boxes controlled by a third operator at the cell.

In these example embodiments, the existing uplink frequency band is shown to include frequencies starting at approximately 1920 MHz, the existing downlink band to include frequencies starting at approximately 2110 MHz, and the new uplink and downlink bands to include frequencies starting at approximately 2500 MHz. However, the present invention is not limited by these frequency values but may be applied to any bands of possible frequencies. The frequencies being shown in FIGS. 5A and 5B here are for illustration purposes only, and does not limit the scope of the present invention.

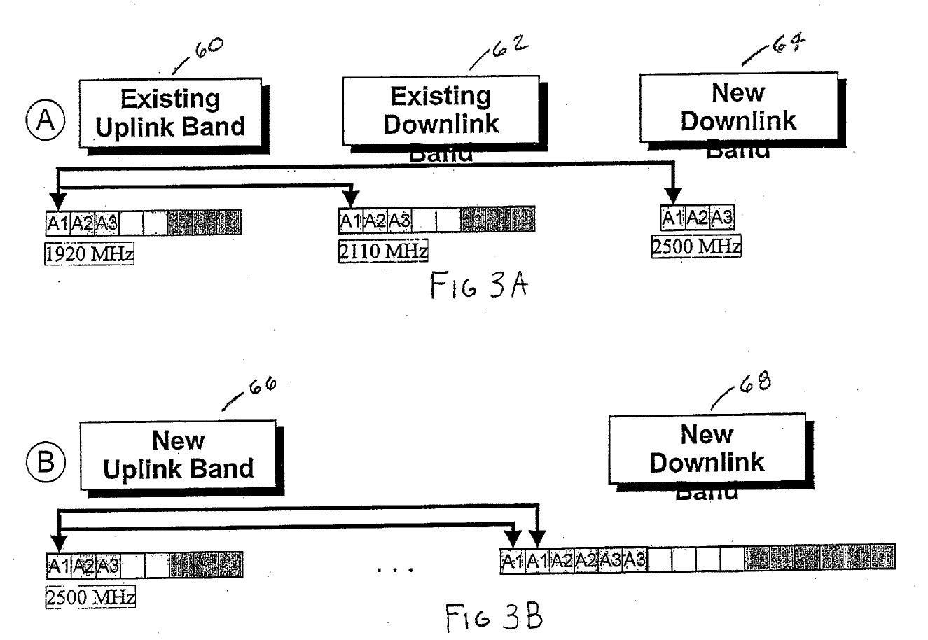

FIG. 3A shows an example embodiment where a mobile node (UE) may be connected with a uplink carrier frequency from an existing uplink band 60 and a downlink carrier frequency from an existing downlink band 62. The existing downlink carrier band 62 may be a core band from a cell closest to the location of the mobile node. A network node may determine that the mobile node should select a second downlink carrier, and direct the mobile node to start using a downlink carrier from frequencies in a new or different downlink band 64 (i.e., from a different cell). The mobile node may then use the uplink carrier from the existing band 60 and a downlink carrier from a new or different downlink band 64.

FIG. 3B shows an example embodiment where a mobile node may have originally been using an uplink carrier from a new uplink band 66 and a downlink carrier from a new downlink band 68. The new uplink band and new downlink band may be from the same band of frequencies (e.g., starting at approximately 2.5 GHz where some frequencies are used for uplink carriers and some for downlink carriers). In this example embodiment, a network node may direct the mobile device to switch over and use a different downlink carrier, but from the same band of frequencies as the original downlink carrier. The frequencies in the new uplink band 66 and the new downlink band 68 may be supplied by the same cell, or from different cells.

FIG. 4 shows a flowchart of a process for uplink interference avoidance according to an example embodiment of the present invention. While demodulating DL channel ch2, S1, intra-frequency RRM measurements may be performed S2. The signal quality on DL ch 2 may also be regularly measured S3. It is determined if the signal quality has deteriorated or is low S4. The low/deteriorated signal quality may be reported to the network through a network device S5. An inter-frequency handover or an inter-system handover may be launched thus avoiding ACLR in an uplink channel 1.

FIG. 5 shows a flowchart of a process for uplink interference avoidance according to another example embodiment of the present invention. While demodulating DL channel ch2, S10, intra-frequency RRM measurements may be performed S11. The signal strength on the adjacent operators DL ch 1 may also be regularly measured S12. It is determined if the signal strength has increased S13. The increased signal strength may be reported to the network through a network device S14. An inter-frequency handover or an inter-system handover may be launched thus avoiding ACLR in an uplink channel 1.

The embodiments shown in FIGS. 4 and 5 show different processes for detection of soft handover areas to avoid uplink channel interference. However, the present invention is not limited to these processes, for example, a process or technique encompassing any combination of actions shown in FIGS. 4 and 5 may also be used for detection of soft handover areas to avoid uplink channel interference and still be within the scope of the present invention.

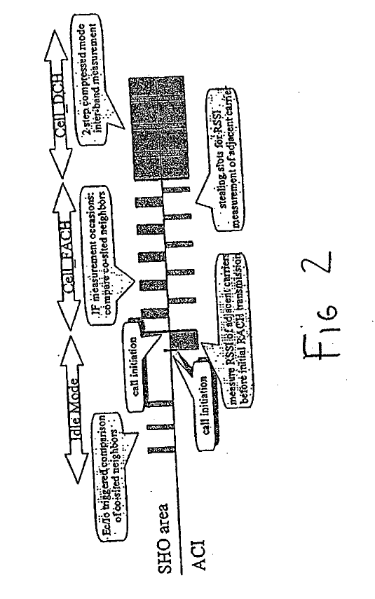

An absolute or relative signal quality level can be applied for the processes shown in FIGS. 1, 2 and a combination thereof to indicate SHO area. In case of relative levels, the SHO parameter “Window_Add” might preferably be used. To distinguish the UL interfering SHO area from any other SHO area, co-siting information DL1-DL2 may be used. In idle mode, Cell_FACH, Cell_PCH, and URA_PCH state the co-siting information preferably is indicated by the network to the mobile over BCCH system information, in Cell_DCH state over DCH. The UE may compare neighbor cell measurements on the carriers DL1 and DL2 to find out whether the same cells are detectable on both of the carriers or not.

The present invention is advantageous in that it allows for the avoidance of severe interference scenarios. Moreover, uplink interference avoidance according to the present invention allows for new frequencies from new bands to be used for uplink and downlink carriers.

It is noted that the foregoing examples have been provided merely for the purpose of explanation and are in no way to be construed as limiting of the present invention. While the present invention has been described with reference to a preferred embodiment, it is understood that the words that have been used herein are words of description and illustration, rather than words of limitation. Changes may be made within the purview of the appended claims, as presently stated and as amended, without departing from the scope and spirit of the present invention in its aspects. Although the present invention has been described herein with reference to particular methods, materials, and embodiments, the present invention is not intended to be limited to the particulars disclosed herein, rather, the present invention extends to all functionally equivalent structures, methods and uses, such as are within the scope of the appended claims.

What is claimed is:

1. A method for uplink interference avoidance comprising:
measuring a signal characteristic of a downlink channel currently not used by a mobile device;
determining if the signal characteristic has increased or decreased;
reporting the signal characteristic increase or decrease to a network device; and
launching a handover from a downlink channel currently used by the mobile device.

2. The method according to claim 1, further comprising launching one of an inter-frequency handover and an inter-system handover from the downlink channel currently used by the mobile device thus avoiding interference in an uplink channel not currently used by the mobile device.

3. The method according to claim 1, further comprising performing intra-frequency measurements on the current downlink channel.

4. The method according to claim 1, wherein the downlink channel currently used by the mobile device is in an extension band of frequencies.

5. The method according to claim 4, wherein the extension band of frequencies comprises frequencies starting at approximately 2.5 GHz.

6. The method according to claim 1, further comprising launching a handover from a downlink channel currently used by the mobile device thus avoiding interference in an uplink channel not currently used by the mobile device, the uplink channel being in a core band of frequencies.

7. The method according to claim 6, wherein the core band of frequencies comprises frequencies starting at approximately 2 GHz.

8. The method according to claim 1, wherein the network device comprises one of a radio network controller (RNC) and a base station controller (BSC).

9. The method according to claim 1, further comprising launching the handover from the current downlink channel by one of the network device and the mobile device.

10. The method according to claim 1, wherein the signal characteristic comprises signal quality.

11. The method according to claim 10, wherein the signal quality comprises CPICH Ec/Io.

12. The method according to claim 10, further comprising determining if the signal quality has deteriorated and reporting the signal quality deterioration to the network device.

13. The method according to claim 1, wherein the signal characteristic comprises signal strength.

14. The method according to claim 13, wherein the signal strength comprises RSSI.

15. The method according to claim 13, further comprising determining if the signal strength has increased and reporting the signal strength increase to the network device.

16. The method according to claim 1, wherein the interference comprises adjacent channel leakage power ratio (ACLR) interference.

17. A system for uplink interference avoidance comprising:
a network device in a communications network; and
a mobile device, the mobile device operatively connected to the communications network and using a downlink channel,
wherein a signal characteristic of a downlink channel currently not used by the mobile device is measured to determine if the signal characteristic has increased or decreased, the signal characteristic increase or decrease being reported to the network device, a handover from the downlink channel used by the mobile device is launched thus avoiding interference in an uplink channel not currently used by the mobile device.

18. The system according to claim 17, wherein the network device comprises one of a radio network controller (RNC) and base station controller (BSC).

19. The system according to claim 17, further comprising launching one of an inter-frequency handover and an inter-system handover from the current downlink channel thus avoiding interference in an uplink channel not currently used by the mobile device.

20. A method for uplink interference avoidance comprising:
measuring a signal characteristic of a downlink channel currently not used by a mobile device;
determining if the signal characteristic has reached a threshold; and
launching a cell re-selection from a downlink channel currently used by the mobile device.
